(19) United States
(12) Patent Application Publication
(10) Pub. No.: US 2005/0257196 A1
(43) Pub. Date: Nov. 17, 2005

(54) System and method for developing new services from legacy computer applications

(76) Inventors: Gideon Hollander, Hod Hasharon (IL); Benjamin Schlesinger, Hasharon (IL); Iddo Levinson, Hasharon (IL); Avner Zangvil, Haifa (IL); Guy Sheffer, Ra'Anana (IL)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 10/846,924

(22) Filed: May 17, 2004

(51) Int. Cl. G06F 9/44; G06F 15/16

(52) U.S. Cl. 717/115; 717/102; 709/202

(57) ABSTRACT

A method of generating a service from at least one existing (legacy) computer software application executable on a MICROSOFT WINDOWS® operating system includes navigating the application(s), intercepting messages between the application(s) and a MICROSOFT WINDOWS® operating system at a WINDOWS messaging layer to automatically capture a plurality of controls and data and to automatically record a script for the application(s), and generating a service for executing the script. The service may be invoked by a Web client or application to exploit the functionality of the legacy application(s).

### BACKGROUND AND SUMMARY

1. Field

This invention pertains to the field of computer software application and service development and more particularly, to a system and method of developing new services and/or applications from legacy computer applications.

2. Description

Business success demands the flexibility to change and improve processes that affect bottom-line savings or top-line growth. The ability to rapidly seize opportunities is paramount. Portal and Web self-service initiatives, CRM and ERP integration, composite application development—any or all of these may be required to make it happen. Information technology (IT) needs to be able to deliver enabling technology as quickly as a business identifies growth opportunities, and service-oriented architectures (SOAs) provide an excellent foundation to enable an application infrastructure to be more dynamic and flexible.

Meanwhile, most businesses have substantial investments in existing computer applications and associated data. There is a growing need to leverage both data and business logic residing in these systems to power new Web and composite applications.

The definition of legacy continues to change in the world of technology. According to the Free On-Line Dictionary Of Computing (FOLDOC), legacy system is defined as: “A computer system or application program which continues to be used because of the prohibitive cost of replacing or redesigning it and despite its poor competitiveness and compatibility with modern equivalents. The implication is that the system is large, monolithic and difficult to modify.”

Brodie and Stonebraker provide the following definition: “Any information system that significantly resists modification and evolution to meet new and constantly changing business requirements.”

In the past, legacy applications are have been best known as “green-screen” mainframe and midrange applications. However, recently MICROSOFT WINDOWS® client/server applications are being categorized as legacy systems. As the information technology industry constantly advances to newer technologies, organizations are facing the challenge of preserving the functionality of existing business logic within MICROSOFT WINDOWS® applications that are gradually becoming legacy. There are some products today that service-enable host and Web applications, but none that can generically address within MICROSOFT WINDOWS® applications.

In the past, there have been two primary options for migrating such existing or legacy application functionality into a service-oriented architecture: rewrite or reuse.

Rewriting business logic provides minimal returns in the short and medium term, and is extremely risky. In addition, most existing systems that are critical to the business tend to be too old, too big, too brittle, or too complicated to be easily understood. This makes a rewrite or restructuring process extremely time consuming, as well as risky.

Reusing business logic can be a tremendous accelerator in delivering meaningful services. Unfortunately, most proven application logic is neither accessible nor structured, so reuse is not a simple proposition.

Consider the standard three-layer model of an application architecture: (1) Presentation—user interface logic; (2) Business Logic—core business functionality; and (3) Data—raw information. MICROSOFT WINDOWS® applications typically combine these layers into what's known as a two-tier architecture (see FIG. 1). This model was popularized during the 1990s, and is often referred to as “fat-client” client/server. These applications were built using 4GL tools like POWERBUILDER®, DELPHI®, ORACLE® FORMS®, SMALLTALK®, LOTUS® NOTES®, Ada, or Visual Basic, or a 3GL like C or C++. In this style, the presentation and business logic layers are combined in a fat client, and there is a separate, structured data layer. Many software vendors in the 1990s built their packages (e.g., Customer Relationship Management (CRM), Enterprise Resource Planning (ERP), etc.) using the two-tier client/server architecture.

In two-tier systems, the intertwining of business logic with presentation logic makes isolating and accessing the business logic difficult, if not impossible. For this reason, companies may consider writing new business logic in .NET or J2EE, and using that logic to access the data in the original application.

While this approach provides for reuse of the data, circumventing proven business logic compromises data integrity, and results in two versions of the transaction or business logic that must be maintained. To further complicate matters, you may not have written, or even have access to, the original source code of the application. In fact, you may not even have a definition of the data model.

The alternative approach of using an application programming interface (API) to access the logic also presents problems. In the first place, most applications do not provide an API. When they do, the API is typically not comprehensive enough to be useful. If an appropriate API is not available, an IT organization may try to restructure the code (if they own it and can understand it), which is extremely risky. Or they may be required to upgrade the application package. Either option is costly and time consuming.

Meanwhile, services, e.g. Web-based services, provide access to key business functionality regardless of implementation details. With just the service interface definition, the service is ready to use. This allows services to be assembled and reassembled to deliver new capabilities and integrate with other applications, quickly and completely changing the delivery mechanism for key business functions.

Accordingly, it would be advantageous to provide a system and method of developing new services or applications from legacy computer applications. It would be particularly advantageous to provide such a method and system that can easily service-enable any MICROSOFT WINDOWS® application. It would still further be advantageous to provide such a system and method that can reuse proven functions of existing software applications with no recoding, and no need to have any knowledge of, or even access to, the underlying code or data structures. Other and further objects and advantages will appear hereinafter.

The present invention comprises a system and method of developing new services or applications from legacy MICROSOFT® WINDOWS® computer applications.

In one aspect of the invention, a method of generating a service from at least one existing computer software application executable on a MICROSOFT WINDOWS® operating system comprises: navigating the application; intercepting messages between the application and a MICROSOFT WINDOWS® operating system at a WINDOWS messaging layer to automatically capture a plurality of controls and data and to automatically record a script for the application; and automatically generating a service for executing the script. The script is a sequential set of orders and instructions that specify how to interact with the screens of the existing computer software application(s).

In another aspect of the invention, a system for generating a service from at least one existing computer software application executable on a MICROSOFT WINDOWS® operating system comprises: script generation means for navigating the application, intercepting messages between the application and a MICROSOFT WINDOWS® operating system at a WINDOWS messaging layer, automatically capturing a plurality of controls and data, and generating a script for the application; and service generation means for automatically generating a service for executing the script.

In yet another aspect of the invention, a method of executing functionality of at least one existing computer software application, executable on a MICROSOFT WINDOWS® operating system, via a service comprises: navigating the application; intercepting messages between the application and a MICROSOFT WINDOWS® operating system at a WINDOWS messaging layer to automatically capture a plurality of controls and data from the application, and to generate a script for the application; and invoking the service on a client device to execute the script with respect to the application. Beneficially, the client device or machine includes a thin client for invoking the service.

In still another aspect of the invention, a system for executing functionality of at least one existing computer software application, executable on a MICROSOFT WINDOWS® operating system, via a service comprises: script generation means for navigating an application and intercepting messages between the application and a MICROSOFT WINDOWS® operating system at a WINDOWS messaging layer to automatically capture a plurality of controls and data and to generate a script for the application; service generation means for automatically generating a service for executing the script; a client device adapted to invoke the service; and means for playing back the script.

### BRIEF DESCRIPTION OF THE DRAWINGS

FIG. 1 shows a three-layer model of a software application architecture;

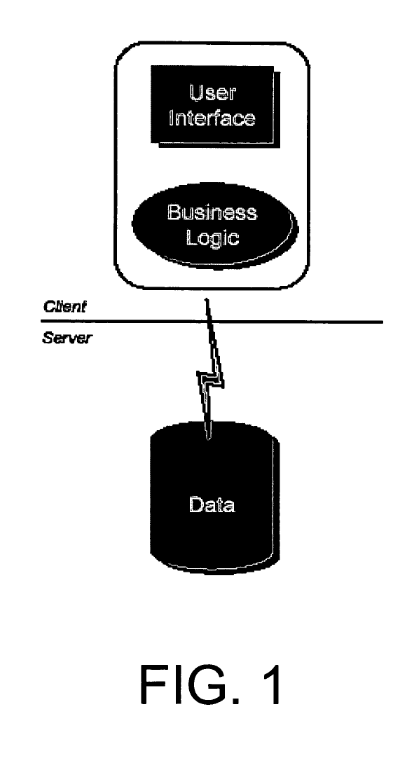

FIG. 2 is a functional block diagram of a system according to one or more aspects of the present invention;

FIG. 3 is a flowchart of a method of developing a new Web-based service from one or more existing software applications;

FIG. 4 is a block diagram of a system for executing functionality of at least one existing computer software application via a Web-based service; and

FIG. 5 is a flowchart of a method of executing functionality of at least one existing computer software application via a Web-based service.

### DETAILED DESCRIPTION

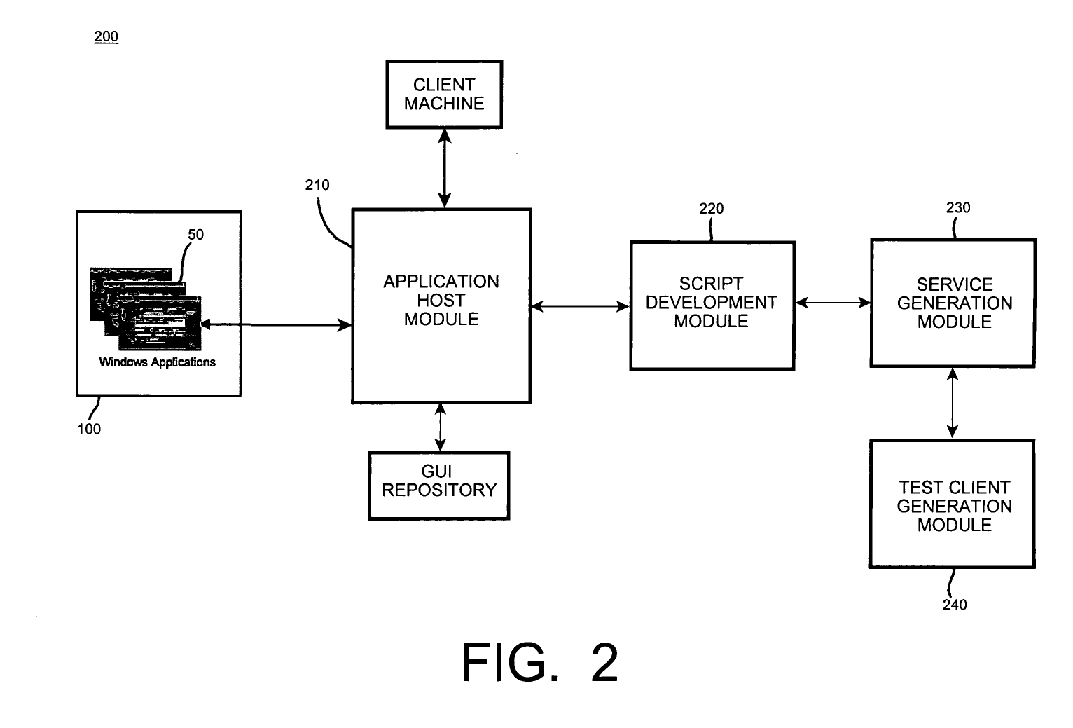

FIG. 2 shows a block diagram of a development system 200 for generating services from one or more existing (legacy) computer software applications. Beneficially, the development system 200 can generate Web services. The development system includes an application host module 210, a script development module 220, a service generation module 230, and optionally a test client generation module 240.

The development system 200 interacts with one or more legacy applications 50 which may or may not physically reside on a same computer terminal as some or all of the development system 200. Beneficially, the development system 200 and application(s) 50 operate under a MICROSOFT® WINDOWS® OS.

The application host module 210 allows a developer to launch and navigate one or more legacy applications 50 that include functionality or logic that is to be incorporated into a new service. As the developer navigates the user interface (UI) of the application(s) 50, the application host module 210 captures controls and data of the UI and generates a raw script, or macro, that can be played back later to access the logic or functionality of the application(s). The application host module 210 captures each GUI object with which the developer interacts as he/she navigates through the UI, and it stores the GUI objects, together with their attributes, in a GUI Repository.

Beneficially, the application host module 210 operates by intercepting messages between the application(s) 50 and the operating system 100. For example, when a button is clicked in some legacy application's UI, the WINDOWS® OS informs the application 50 that the button was pressed. Sometimes when an application draws on a display screen, the result is not an object which can be referred to by the application host module 210. In that case, the application host module 210 may employ interception of Graphics Device Interface (GDI) calls to capture any graphics actions performed by the application 50.

In creating a new service, many different applications 50 may be navigated, and the application host module 210 generates a raw script that accesses the desired functionality of all of the applications 50.

At this time, the script development module 220 automatically generates source code for the raw script for a desired programming language/environment. Alternatively, a developer may manually program the script from the controls that have been captured and stored in the repository. Beneficially, the script development module 220 includes a script editor and debugger. The script development module 220 allows a developer to define input/output and to add logic to the raw script generated by the application host module 210 to produce a finalized script.

The service generation module 230 generates a service for the finalized script produced by the script development module 220. Beneficially, the service generation module 230 generates a Web service proxy that can run in a standard Web server. The Web service can be consumed by one or more runtime environments. Beneficially the Web service can be consumed by both J2EE and .NET runtime environments.

The test client generation module 240 automatically generates a user-interface (UI) for a test client for testing the newly-created service. Beneficially, the test client is HTML-based. The UI can be used to enter input parameters of the newly-crated service, to invoke the service, and to view output parameters of the service to validate the operation of the generated service.

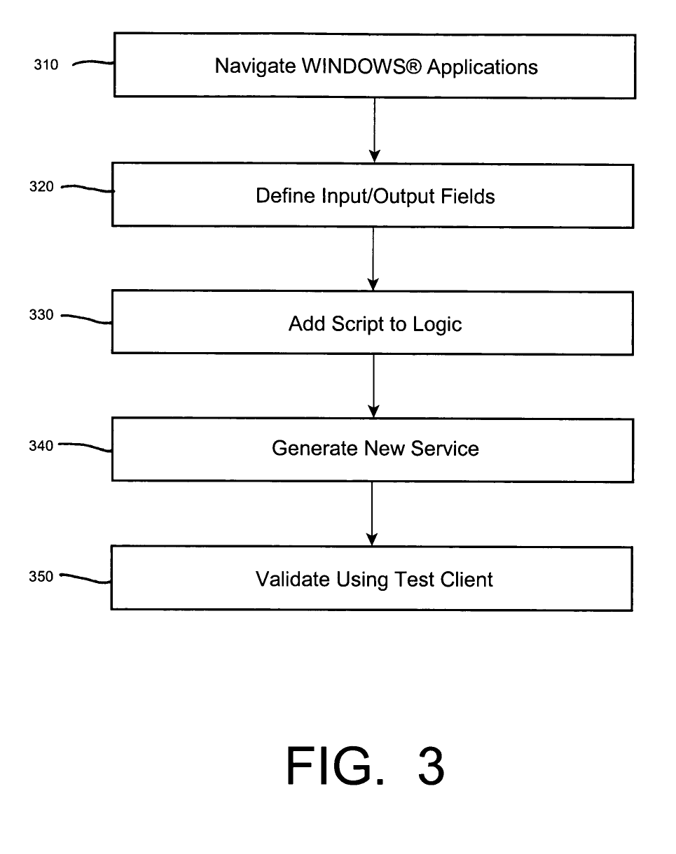

FIG. 3 is a flowchart of a method 300 of developing a new service (e.g., a Web-based service) from one or more existing software applications, which may use the development system 200.

In a first step 310, the developer records all of the user actions by navigating through the application(s). This is essential for collecting the necessary information pertaining to the application's behavior and for analyzing components of the application's user interface. To accomplish this, the application host module 210 automatically captures the user interface objects (controls) and data while the user navigates the application(s). Each GUI object, along with the corresponding properties identified during the recording process, is automatically added to the GUI Repository.

It is also possible to manually add one or more user interface objects to the GUI Repository without recording a script. For example, beneficially a user can point to and add a specific GUI object to the GUI Repository while navigating an application. Also beneficially, a user may select an option to automatically capture all GUI objects in a Window to which the user has navigated. The user may navigate from window to window in the application and thereby capture all GUI objects that appears along the way. This may be beneficial to allow a user to write code to invoke functions which cannot be recorded, such as data retrieval, or to add obscured controls, which cannot be reached when recording a script, to the GUI Repository.

At the end of the recording phase, a raw script is automatically generated, describing all the developer actions that were recorded. The raw script can be immediately “played back” to verify that it is correct. Alternatively, a developer may manually program the script from the controls that have been captured and stored in the GUI Repository.

In an optional step 320, the developer defines input and output from the application and sets the corresponding parameters for the service interface (e.g., a Web interface).

In a step 330, the developer adds logic to the generated script. This step enables the developer to meet additional business requirements and to handle complex application behavior. Beneficially, the script development module 220 generates the script source code in any NET compatible language. Using the script editor and debugger of the script development module 220, the developer can extend the functionality of the script generated by the application host module 210.

In a step 340, once the recording and scripting process is complete, the service generation module 230 generates a service for the script generated in steps 310-330. Beneficially, the service generation module 230 generates a Web service proxy that runs in a standard Web server. Beneficially, the Web service proxy can be easily invoked by integrated development environments (IDE) and consumed by both J2EE and .NET runtime environments. However, IDE is only one example. To consume the Web service, a developer can either write code or use an off-the-shelf code library (toolkit) that does this for him/her. In the case of generating a Web service, beneficially, the Web service adheres to Simple Object Access Protocol (SOAP) 1.1 and Web Service Definition Language (WSDL) 1.1 standards, and can be published in a standard Universal Description, Discovery, and Integration (UDDI) registry.

Finally, in a step 350, the developer tests the generated service. Beneficially, the service generation module 230 automatically generates a user interface for a test client which is used to enter the input parameters, invoke the service, and view the resulting output fields, providing validation of the generated service. Beneficially, the service generation module 230 automatically generates an HTML-based UI for the test client.

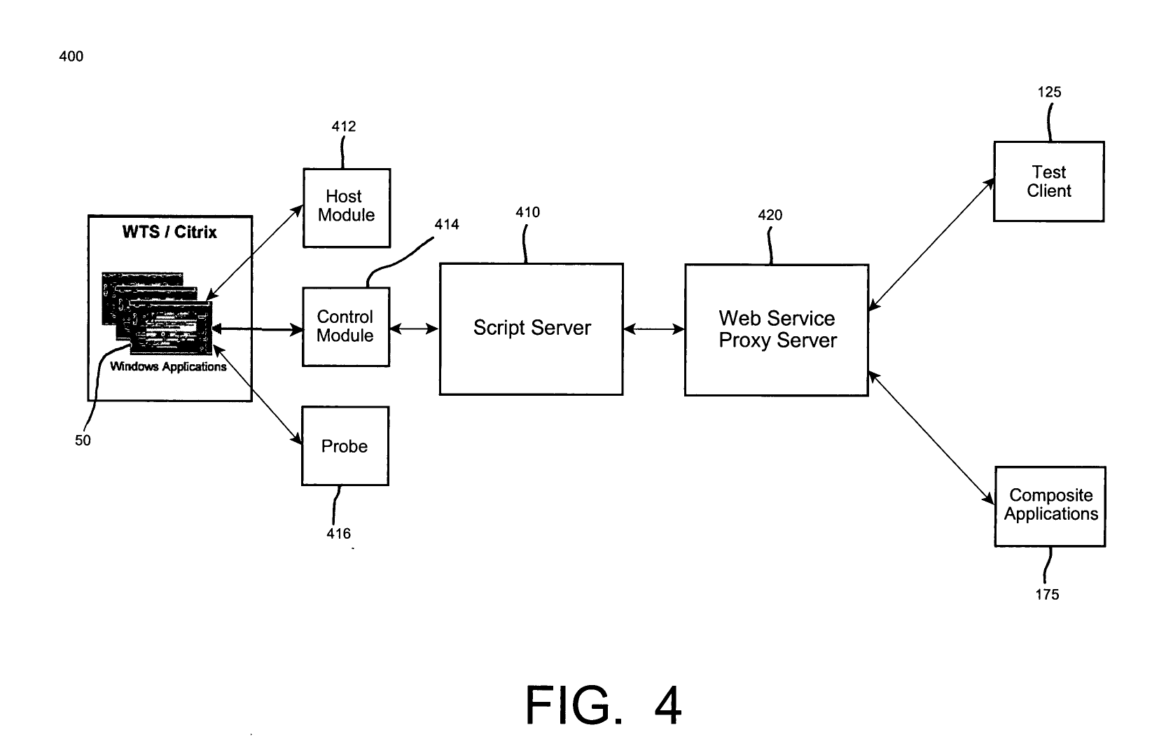

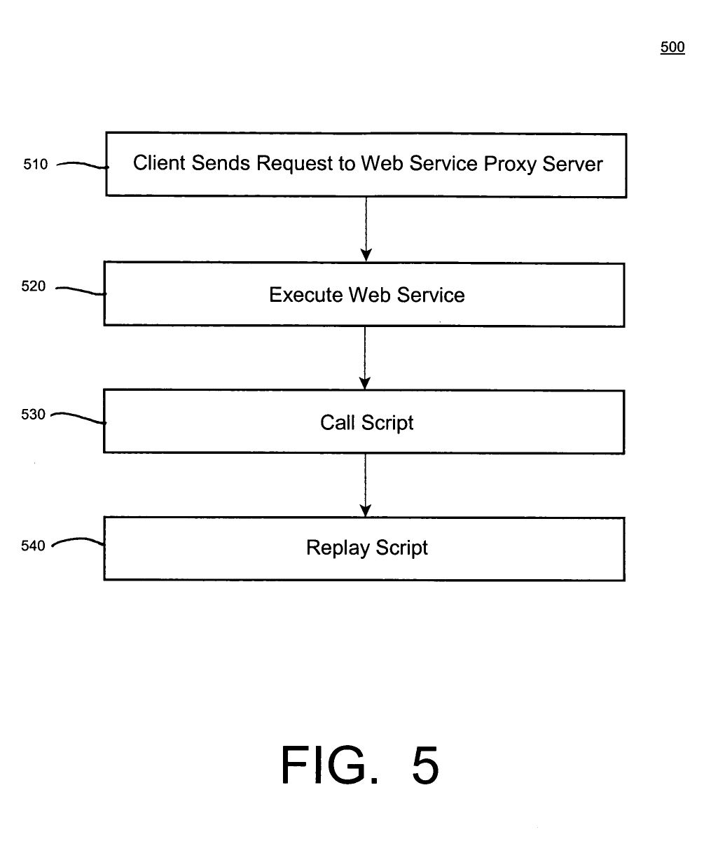

FIG. 4 is a block diagram of a deployment system 400 for executing functionality of at least one existing computer software application via a Web-based service, and FIG. 5 is a flowchart of a method of executing functionality of at least one existing computer software application via a Web-based service.

Although FIGS. 4 and 5 pertain specifically to a Web-based service, it is to be understood that this is only one specific exemplary type of service that can be generated and invoked according to the systems and methods described herein. Indeed, the services generated by the system 200 and the method 300 can be invoked by various techniques. For example, generated services can be invoked from .NET applications directly using .NET remoting, without using SOAP or a Web server. So a WSDL service is only one type of service. Similarly, although in the example of FIGS. 3 and 4 the test client has an HTML-based UI, this is understood to be only one possible implementation. For example, the UI for the test client could be generated using WINFORMS® or any convenient UI toolkit.

Turning to FIG. 4, the deployment system 400 includes a script server 410, a host module 412, a control module 414, one or more probes 416, and a Web service proxy server 420. The system 400 interacts with one or more legacy applications 50 that beneficially reside on a same computer machine as the host module 412, control module 414, and probe(s) 416. Beneficially, the system 400 and application(s) 50 operate under a MICROSOFT® WINDOWS® OS. The Web service proxy server 420 communicates with one or more test clients 125 and/or composite applications 175.

The script server 410 is responsible for facilitating communications between the generated Web service and the legacy application(s) 50. In essence, script server 410 simply replays the finalized scripts (including logic and user modifications) that were generated during the development process (e.g., the method 300 of FIG. 3). These scripts are stored in script server 410 and are activated via a Web service request from the Web service proxy server 420.

The script server 410 communicates with the application(s) 50 by interacting with the application's GUI objects according to their logical position in the UI architecture, not according to their screen coordinates. This ensures a highly reliable connection that is not dependent on the appearance of the user interface (UI), but instead communicates directly to the application's individual screen components and data. Beneficially, by utilizing MICROSOFT®'S WINDOWS TERMINAL SERVICES® (WTS) or CITRIX® METAFRAME PRESENTATION SERVER®, for example, the script server 410 is able to support multiple concurrent sessions.

The host module 412 is a process that runs as a service on the same machine where the application(s) 50 is running. It can be launched automatically and run as a service, or it can be launched manually and run as an application. The host module 412 is responsible of desktop management (open/close CITRIX®/WTS® desktops, etc.).

The control module 414 controls the application(s) 50. The script runs in a script server session and sends requests to the control module 414 to perform actions or query information from the application 50. Beneficially, the control module 414 runs in a CITRIX®/WTS® desktop and it is an external process to the application 50.

The probe module 416 manages things that must be performed from within the application 50 and cannot be handled by the control module 414. The probe module 416 is actually running within the application 50. There is one probe module 416 per application process (there might be several processes per application 50). There is one control module 414 on the desktop that talks to all the probe modules 416.

Although the system 400 is described here with respect to client/server applications, the system can actually handle 1-tier, 3-tier, or n-tier configurations as well. Indeed, since the script server 410 communicates with the legacy application(s) 50 by interacting with the application's GUI objects, it only needs to interact with a client for the legacy application(s) which be served by a remote server.

Beneficially, the system 400 can provide one or more of the following benefits, described in further detail below: session management, security and single sign-on, scalability, and administration.

Beneficially, with each request to execute a script, the script server 410 creates a script server session to access the application(s) 50. In the context of a MICROSOFT® WINDOWS® OS, initialization typically includes starting a WTS or CITRIX® session in addition to starting the application 50 and navigating to a specific screen. Accordingly, starting a new session for each user has the potential to be expensive in terms of both CPU usage and response time. Beneficially, in order to minimize the number of sessions that need to be created and to reduce the time it takes to initialize a new session, the script server 410 offers session pooling, which makes it possible to configure a pool of sessions for each script hosted in the script server 410. The session pools can be partitioned in such a way as to guarantee that a specific number of idle (initialized) sessions will be available for a specified group of users. Beneficially, the script server 410 also provides the ability to save and manage session state. This allows a session to be associated with a specific user for an extended period of time. This capability is useful in the following scenarios:
1. A complete process requires interaction with multiple services executing against a single WINDOWS® application. For example, a user may invoke a transaction that displays a list of orders, and then may need to select an order from that list, to display its details.
2. A user who is required to log in with an ID and password needs to work with an application 50 for an extended period of time and is required to re-enter the ID and password each time the application 50 invokes a Web service. For example, a call center user who logs into the application at the start of a shift, and then works with the application throughout the shift may have to log in repeatedly. In this scenario, dedicating a script server 410 session to the user improves performance by eliminating these subsequent logins.

Beneficially, the script server 410 may be used to integrate an application (e.g., a WINDOWS® application) with a Web-based application where specific Web user IDs are not mapped one-to-one to IDs for the MICROSOFT® WINDOWS® OS or applications. The script server 410 offers a user ID mapping capability to allow administrators to generalize access to the OS 100 and associated applications 50, allowing users to have a single sign-on experience. For example, script server 410 maps all external portal users to a single ID in the application, thereby requiring a single login to the new client application (i.e. portal), and not requiring an application-specific or OS-specific ID and password.

Beneficially, the script server 410 coexists with and utilizes the scalability mechanisms that are provided by tools such as CITRIX®, WTS®, Web servers, hardware load balancers, etc. Beneficially, in the context of a MICROSOFT® WINDOWS® OS, the script server 410 leverages: (1) CITRIX®/WTS® to manage multiple desktops on a single machine; (2) Web servers that can be configured to run in a farm of servers as well, either by utilizing the MICROSOFT® WINDOWS® operating system's built-in load balancing mechanisms, or by utilizing external load balancing hardware.

Beneficially, the script server 410 provides an administration console that displays details and real-time performance information for every session in the system. Beneficially, the script server 410 generates performance data that can be monitored by the standard MICROSOFT® WINDOWS® Performance Monitor, enabling administrators to analyze server performance and usage, and to receive alerts when configurable thresholds are met or exceeded.

Turning now to FIG. 5, in a step 510 a client 125 sends a request, beneficially a Simple Object Access Protocol (SOAP) request, to the Web service proxy server 420. When the Web service proxy is invoked, a WSDL page is automatically generated. The WSDL page represents the interface of the Web service, and is used by client applications to understand how to serialize and de-serialize the SOAP request and corresponding response.

In a step 520, in response to the SOAP request, the Web service proxy server 420 finds and executes the Web service proxy.

In a step 530, the Web service proxy calls the appropriate script running in the script server 410.

In a step 540, the script server 410 then replays the script against the legacy application(s) 50 and returns the results to the requesting application 175 or client 125.

The following examples help explain operations of a development system for generating a new service from at least one existing (legacy) computer software application, and a system for executing functionality of a legacy computer software application via a newly generated service.

### EXAMPLE 1

Consider a vendor that wants to enable their customers to buy services directly over the Web (as opposed to phoning orders into the call center). Assume that the vendor currently uses a “fat-client” sales system comprising a heavily customized Windows-based Customer Relationship Management (CRM) application (legacy application) which is currently used for managing customer orders received via a call center.

One option would be to integrate a Web portal directly with the CRM database, but this would circumvent their business rules and put the integrity of the database at risk, making this approach unacceptable.

Another option might be to migrate to a newer version of the CRM application which would provide a Web interface. However, the upgrade might be lengthy and extremely expensive (for example, the process may involve transforming custom code that is part of the current fat-client deployment).

However, with a method of generating a Web service from a legacy computer software application, such as the method 300 disclosed above, the vendor is able to non-intrusively integrate the fat-client CRM application with the portal, leveraging 100% of the business rules contained in the application. By recording discrete processes and transforming them into consumable Web services, the portal application offers a true end-to-end sales capability enabling their customers to purchase services directly via the Web.

### EXAMPLE 2

Consider an organization that operates a large number of facilities (e.g., warehouses) and manages contracts for their construction. Assume that this organization currently manages the procurement process using a POWERBUILDER®-based procurement application (“procurement application”), and manages information about its facilities using a custom-built mainframe-based application (“facilities management application”). Also assume that, to complete the contract management process, a user has to first enter data into the procurement application, then re-enter the data into the facilities application, record a return code generated by the facilities management application, then enter the return code in the procurement application. This process requires a user to perform redundant steps that are time consuming and error prone. Therefore, it would be beneficial for the organization to provide a single user interface for coordinating the functions of these two applications.

However, assume that the organization does not have access to the POWERBUILDER® source code for the procurement application, eliminating any possibility of a rewrite or a restructuring-based approach. In addition, it is likely that the mainframe source code for the facilities management application contains complex value-added business logic that makes it very difficult to build traditional interfaces.

Such situations are not unusual for large organizations that have built internally and/or contracted out for the provision of custom applications over time as their needs have changed.

By using the development system 200 and deployment system 400, this organization can service-enable their existing “untouchable” systems and automate the process (see FIG. 6).

One potential solution is centered around a Java-based control program that automatically: (1) Calls a Web service to retrieve the list of awarded contracts; (2) Calls a Web service to enter the contract data into the POWERBUILDER®-based procurement application; (3) Calls a Java service to enter the data into facilities management application (mainframe); and (4) Takes the return code from facilities management application and calls a Web service to enter the code into the POWERBUILDER®-based procurement application. The Web service(s) can all be created by navigating through the procurement and facilities management applications and creating a script using the development system 200, as explained above.

This process can be is completely automated, and eliminate redundant, error-prone data entry, resulting in a savings of time and money.

In both examples above, it is noted that, by using the systems and methods described herein, a developer is able to construct new services which access the underlying functionality of the legacy applications without needing any source code or API for any of the legacy applications.

While preferred embodiments are disclosed herein, many variations are possible which remain within the concept and scope of the invention. Such variations would become clear to one of ordinary skill in the art after inspection of the specification, drawings and claims herein. The invention therefore is not to be restricted except within the spirit and scope of the appended claims.

1. A method of generating a service from at least one existing computer software application executable on a MICROSOFT WINDOWS® operating system, comprising:
navigating an application;
intercepting messages between the application and a MICROSOFT WINDOWS® operating system at a WINDOWS messaging layer to automatically capture a plurality of controls and data from the application;
generating a script for the application; and
generating a service for executing the script with respect to the application.

2. The method of claim 1, wherein the script is automatically generated.

3. The method of claim 2, further comprising manually adding logic to the automatically generated script before generating the service.

4. The method of claim 1, further including storing graphical user interface (GUI) objects of the application in a GUI repository.

5. The method of claim 1, where navigating the application includes activating at least one graphical user interface (GUI) object on a display screen of the application.

6. The method of claim 1, further comprising automatically generating a user interface for a test client to validate the generated service.

7. The method of claim 1, wherein the service is a Web service that can be executed by a Web server.

8. The method of claim 1, further comprising navigating a second application to automatically capture a plurality of controls and data from the second application, wherein the service also executes the generated script against the second application.

9. The method of claim 1, further including defining at least one input/output parameter of the application.

10. A system for generating a service from at least one existing computer software application executable on a MICROSOFT WINDOWS® operating system, comprising:
script generation means for navigating an application, intercepting messages between the application and a MICROSOFT WINDOWS® operating system at a WINDOWS messaging layer, automatically capturing a plurality of controls and data from the application, and generating a script for the application; and
service generation means for automatically generating a service for executing the script.

11. The system of claim 10, wherein the script generation means is adapted to automatically generate the script in response to navigating the application.

12. The system of claim 11, further comprising means for manually adding logic to the automatically generated script.

13. The system of claim 10 further including a GUI repository for storing graphical user interface (GUI) objects of the application.

14. The system of claim 10, further comprising a test client to validate the generated service.

15. The system of claim 10, wherein the service generation means is adapted to generate a Web service that can be executed by a Web server.

16. The system of claim 10, further comprising means for defining at least one input/output parameter for the application.

17. A method of executing functionality of at least one existing computer software application, executable on a MICROSOFT WINDOWS® operating system, via a service; comprising:
navigating the application;
intercepting messages between the application and a MICROSOFT WINDOWS® operating system at a WINDOWS messaging layer to automatically capture a plurality of controls and data from the application, and to generate a script for the application;
generating a service for executing the script; and
invoking the service on a client device to execute the script with respect to the application.

18. The method of claim 17, further comprising:
starting a session to access the application;
playing back the script; and
returning results from the application to the client device.

19. The method of claim 18, wherein playing back the script includes interacting with graphical user interface (GUI) objects of the application according to their logical position in a GUI hierarchy for the application.

20. The method of claim 17, where the service is a Web service.

21. The method of claim 17, further comprising navigating a second application to automatically capture a plurality of controls and data from the second application, wherein the service also executes the generated script against the second application.

22. The method of claim 17, further comprising automatically generating a user interface for a test client to validate the generated service.

23. The method of claim 17, wherein the script is automatically generated.

24. The method of claim 23, further comprising manually adding logic to the automatically generated script before generating the service.

25. The method of claim 17, further including storing graphical user interface (GUI) objects of the application in a GUI repository.

26. The method of claim 17, wherein intercepting messages between the application and the operating system includes intercepting GDI calls.

27. The method of claim 17, where navigating the application includes activating at least one graphical user interface (GUI) object on a display screen of the application.

28. The method of claim 27, further comprising intercepting a message between the application and the WINDOWS® operating system when the GUI object activated.

29. The method of claim 17, further including defining at least one input/output parameter of the application

30. A system for executing functionality of at least one existing computer software application, executable on a MICROSOFT WINDOWS® operating system, via a service; comprising:
script generation means for navigating an application and intercepting messages between the application and a MICROSOFT WINDOWS® operating system at a WINDOWS messaging layer to automatically capture a plurality of controls and data and to generate a script for the application;
service generation means for automatically generating a service for executing the script;
a client device adapted to invoke the service; and
means for playing back the script.

31. The system of claim 30, wherein the service generation means is adapted to generate a Web service that can be executed by a Web server.

32. The system of claim 30, further comprising means for automatically generating a user interface for a test client to validate the generated service.

33. The system of claim 30, wherein the script generation means automatically generates the script in response to navigating the application.

34. The system of claim 33, further comprising means for manually adding logic to the automatically generated script before generating the service.

35. The system of claim 30, further including a GUI repository for storing graphical user interface (GUI) objects of the application.

36. The method of claim 30, wherein intercepting messages between the application and the WINDOWS® operating system includes intercepting GDI calls.
